(19) United States
(12) Patent Application Publication
(10) Pub. No.: US 2008/0244914 A1
(43) Pub. Date: Oct. 9, 2008

(54) Cable actuated indexing trimmer head compressor

(76) Inventors: David Harris, Rio Oso, CA (US); Charles Paddock, Lancaster, NY (US)

Correspondence Address: MATHEW J. TEMMERMAN, 423 E. STREET, DAVIS, CA, 95616, US

(21) Appl. No.: 11/784,490

(22) Filed: Apr. 6, 2007

(51) Int. Cl. A01D 34/416

(52) U.S. Cl. 30/276

(57) ABSTRACT

The current invention provides a cable actuated string trimmer head compressor, adaptable to bump-n-feed type string trimmers. A handle operated by remotely actuates a lever that in turn exerts force on a first half of a string trimmer head, compressing the first half of the trimmer head relative to a second half of the trimmer head. The string trimmer head compresses as if it had been pressed to the ground.

### BACKGROUND OF THE INVENTION

1. Field of the Invention

The present invention relates to flexible filament cutting devices, particularly to the class comprising “bump-n-feed”-type devices.

2. General Background

This invention provides an improved flexible monofilament cutting device (hereinafter string trimmer) and, more particularly, to the “bump-n-feed” class of string trimmers. Generally, string trimmers comprise a cutting head at the end of a long shaft with a handle or handles. The flexible monofilament cutting elements (hereinafter line) are coiled around a spool, which during operation rotates at a high rate of speed. String trimmers are generally powered by an internal combustion engine typically located on the end of the shaft opposite the cutting head, but electric string trimmers are coming into common use.

A string trimmer works on the principle of centrifugal force. When a trimmer head is subjected to a high enough rotational velocity, centrifugal force holds the flexible filament lines pointed stiffly radially outward. The faster the head turns the stiffer the line acts due the centrifugal force. To protect the operator, the head typically contains a safety shield on the operator side.

It is well known that during normal operation of weed trimmers the cutting elements commonly break, fray, and otherwise have their lengths shortened due to numerous impacts with objects. Shorter elements do not cut with the same diameter swath, and eventually they must be replaced or lengthened in some fashion. One of the most popular means of solving this problem is the use of what has been popularly called a “bump-n-feed” head for the trimmer.

The first bump-n-feed trimmer was disclosed in now-expired United Kingdom Patent No. 1,574,382 and uses an escapement mechanism comprising two discs having inwardly projecting teeth. When the two discs are compressed together, the discs are allowed to slide slightly past each other but only by a fixed amount, thereby allowing a fixed amount of line to be released from the reel. This allows the user to ration his or her line, while at the same time preventing the over-torquing of the small motors normally associated with trimmers. Nearly all bump-n-feed trimmers currently in use employ a similar mechanism for indexing a set amount of flexible line, although some allow an unlimited amount of line to be spooled out so long as the trimmer head remains pressed against the ground. There are numerous citations to the above patent, and bump-and-feed trimmers are now well known.

Nearly all of the bump-n-feed devices currently available require the trimmer head to be knocked against the ground in order to index the line. The pressure applied between the ground and the shaft of the trimmer is generally transferred through a nub on the head, thereby compressing the entire head, allowing the internal spool of line to advance. The only requirement in the compressed head is that one portion of the head move relative to the other—it can be understood all movement between a top part of the head and a bottom part of the head is merely relative to one another. After being knocked against the ground, a coil spring inside the trimmer urges the head back to its original configuration. Descriptions and drawings of typical trimmer heads can be found in U.S. Pat. No. 4,584,771 to Tillotson, U.S. Pat. No. 4,633,588 to Pittinger, Jr., U.S. Pat. No. 4,656,739 to Pittinger, and U.S. Pat. No. 5,623,765 to Woods. The bump-n-feed trimmer's structure is well known in the art, and descriptions of the internal specifics are myriad. Hence, the description will not be repeated in the present application.

There are several problems common to bump-n-feed trimmers. First, to index trimmer line, the operator of a string trimmer will normally strike the trimmer head against this ground. Additionally, this is normally done while the trimmer is spinning at a high rate of speed. In order for enough centrifugal force to advance the line, high speeds are generally necessary. Thus, the moving trimmer head comes into contact with the ground under pressure sufficient to cause a large amount of friction. Upon consideration that for a normal 20 foot spool of string, the above indexing process occurs between 400-500 times, it is easily understood why the high speed striking of the string trimmer against the ground has become a common cause for the wearing out of trimmer heads.

Second, because the head is generally pressed against the ground in order for line indexing to occur, the line is necessarily in a position very close to the ground, and will strike any nearby vegetation. In a grass field this may create small patches where the vegetation is cut down by an amount more than desired by the user. In order to effectuate operation of the indexing process, and to avoid scalping the ground for longer than is necessary, it is very common for the operator of a weed trimmer index the line by slamming the head on the ground quickly. Over the life of the trimmer, the shock and wear from the repeated impacts with the ground can deteriorate the trimmer.

### OBJECTS OF THE INVENTION

There is thus a current need for a cost effective automatic bump-n-feed device that need not be pressed against any external object in order to index a set amount of line.

It is a further object of the invention to reduce manufacturing costs by providing an automatic line indexer that is easily adaptable to any trimmer head utilizing the bump-and-feed method for indexing line.

### SUMMARY OF THE INVENTION

Stated generally, the current invention provides a means to compress the head of a bump-n-feed trimmer without need compression against external means, i.e. the ground. A handle and cable adapted to a trimmer allows the operator to compress the head with the pull of the handle, thus eliminating the need to ever bump the trimmer against the ground.

### SHORT DESCRIPTION OF THE DRAWINGS

The accompanying drawings are included to provide a further understanding of the invention and are incorporated in and constitute a part of this specification, illustrate an embodiment of the invention and together with the description serve to explain the principles of the invention.

FIG. 1—is a perspective view of the shaft and head of a trimmer with the present invention attached thereto. The hand of an operator is shown grasping a handle that pulls the cable, ultimately compressing the head to index an amount of line.

FIG. 2—is a close perspective view of the head of a trimmer having the current invention attached thereto. The cable and lever arm are depicted here as being in a first configuration.

FIG. 3—is identical to FIG. 3 except for in FIG. 3 the cable has been tightened, and the lever arm repositioned. Whereas FIG. 2 depicts the cable and lever arm in a first configuration, FIG. 3 depicts them in a second configuration.

FIG. 4—is a cross section taken through line 4-4 on FIG. 3.

FIG. 5—is a cross section taken through line 5-5 on FIG. 4.

FIG. 6—is identical to FIG. 5 except for in FIG. 6 the cable has been tightened, and the lever arm repositioned. Whereas FIG. 5 depicts the cable and lever arm in the first configuration, FIG. 6 depicts them in the second configuration.

### DETAILED DESCRIPTION OF THE INVENTION

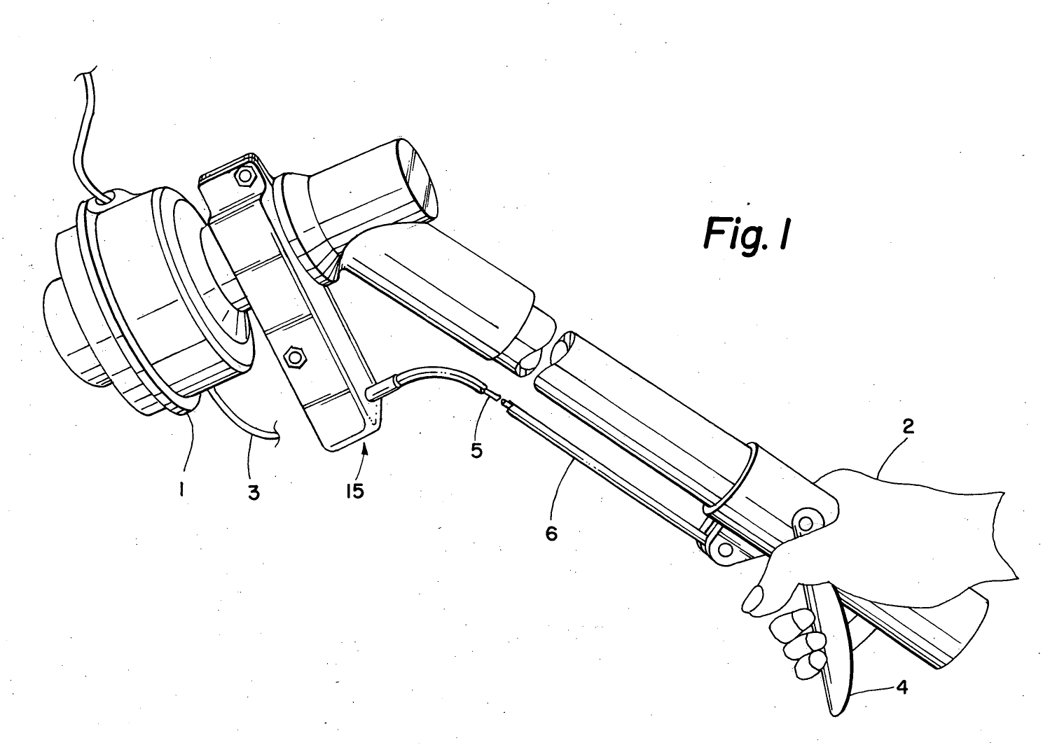

Turning first to FIG. 1, the current invention is a device adaptable to any bump-n-feed trimmer head 1 that provides a means for the operator 2 of a trimmer to advance trimmer line 3 from the trimmer head 1 without the need to bump the trimmer head 1 against the ground. The invention adapts equally well to either internal combustion trimmers or electric trimmers.

A handle 4 and cable 5 adapted to a trimmer allows the operator to compress the head with the pull of the handle 4, thus eliminating the need to ever bump the trimmer against the ground, or against any object external to the trimmer itself. The cable 5 may be protected in a cable sheath 6. Although preferably a Bowden cable is used, in practice any small cable capable of transmitting mechanical force may be used. To protect the cable, a plastic cable sheath 6 may be wrapped around it.

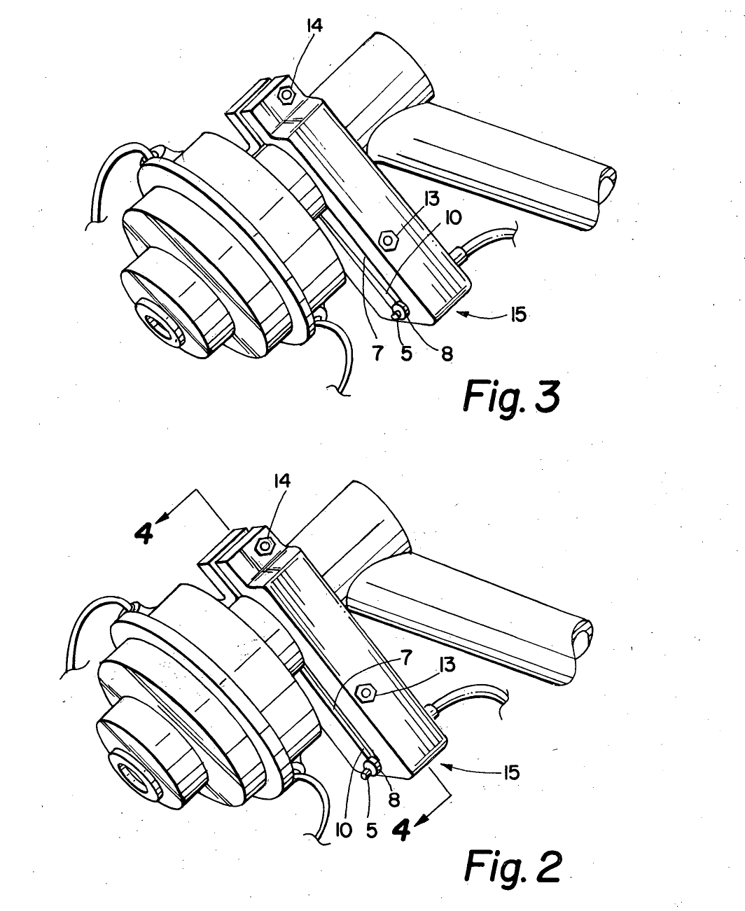

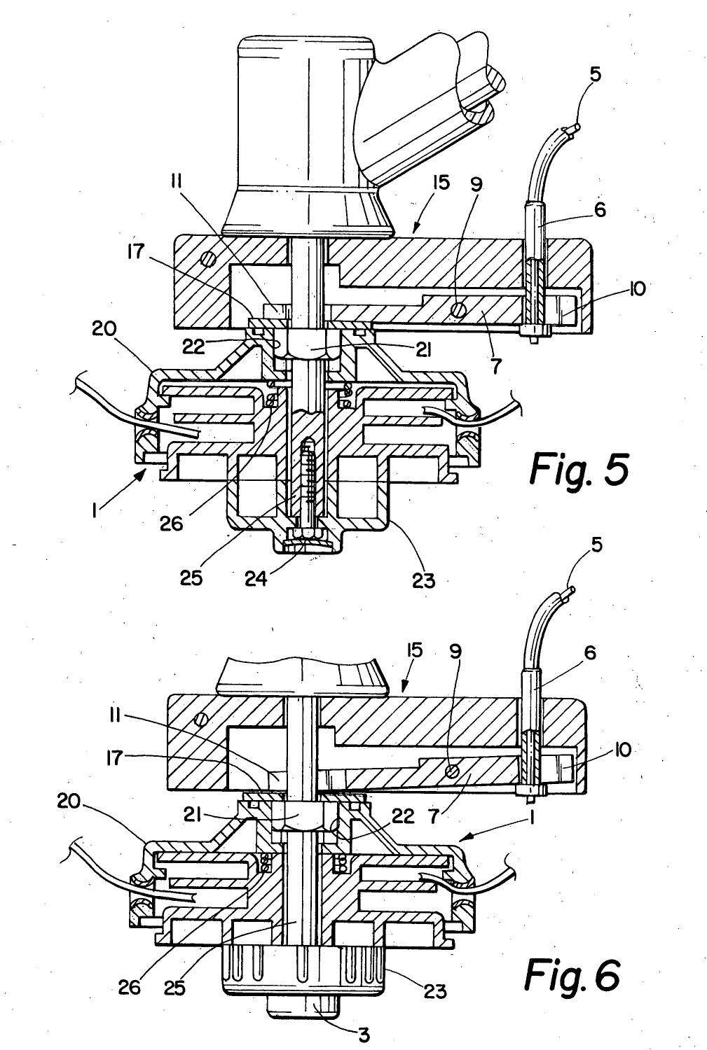

The cable is used to transmit mechanical force from the handle 4 to a lever (see reference number 7, FIG. 5.), which is a component of a head compressor 15. See FIG. 2. Continuing with FIG. 2, a first end 10 of said lever 7 is visible. First end 10 comprises an aperture (not shown) through which said cable 5 is threaded. A cable tie 8 on an end of said cable 5 prevents the cable from slipping back through the first end aperture (not shown) when a pulling force is exerted on the cable. Instead, the cable tie 8 causes the cable 5 to catch on the first end 10, thereby transmitting the pulling force to said first end 10 and reconfiguring the device to the configuration shown in FIG. 3. For purposes of this application, the configuration depicted in FIG. 2 will be referred to as a first configuration and the configuration depicted in FIG. 3 will be referred to as a second configuration.

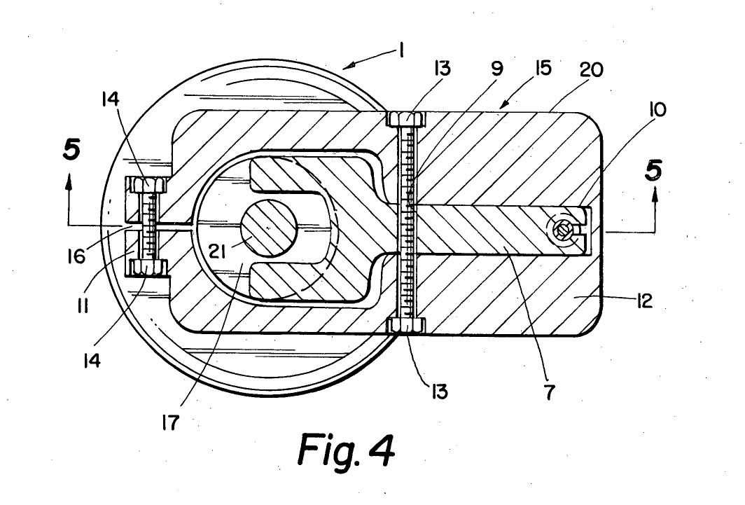

FIG. 4 depicts a cutaway view of the lever 7 as the lever housing 12 in which lever 7 sits. Lever axis 9 is clearly visible in this image, and is secured into place by two locking nuts 13. It in this view where the lever second end 11 is first visible. As the lever moves about axis 9, as the first end 10 rotates counter-clockwise upon actuation, the second end 11 rotates clockwise. Likewise, as the lever first end 10 moves back to the first configuration by rotating clockwise about the lever axis 9, lever second end 11 moves counter-clockwise. The lever components and lever housing may be fashioned from any hard material able to withstand typical outdoor gardening use, such as hard plastic or aluminum.

Referring briefly back to FIG. 2, attention is brought to the head compressor 15. Head compressor 15 comprises lever housing 12 (see FIG. 4), lever 7, locking nut 13 and other components described previously or to be described. Through the center of head compressor 15 is threaded a trimmer shaft 21 (see FIG. 4). A gap 16 exists between two forks of trimmer compressor 15, and this gap is narrowed by tightening two tightening nuts 14. Continuing to refer to FIG. 4, a washer 17 is depicted just on top of said trimmer head 1.

Washer 17 is also depicted in FIGS. 5 and 6. Similar to FIGS. 2 and 3, FIGS. 5 and 6 are identical but for the difference in configurations. FIG. 5 depicts the device in a first configuration, and FIG. 6 depicts the device in a second configuration, wherein in said second configuration lever 7 has rotated slightly counter-clockwise about lever axis 9. Thus, FIG. 5 corresponds to the configuration in FIG. 2 and FIG. 6 corresponds to the configuration in FIG. 3.

The trimmer head shown in FIGS. 5 and 6 and referred to throughout this patent application is a generic simplified version of a bump-n-feed trimmer head. As such trimmer heads have been commonplace for two decades, there is no need to describe in detail how a line actuator works. For reference to this, see the patents indicated in the background portion of this invention, as well as patents referencing the listed patents. The common detail required in any bump-n-feed trimmer head to be applied to this invention is compression of one portion of the trimmer head relative to another portion of the trimmer head, whereby through said compression, line is unspoiled from the trimmer head.

Continuing on with FIGS. 5 and 6, a shaft nut 21 is secured to a trimmer head post 25 at the end of a trimmer shaft. This shaft nut 21 fits snugly in a hex groove 22. Rotational motion from the shaft nut 21 is imparted to the trimmer head 1 due the inability of the shaft nut 21 to rotate within the hex groove 22. This is well known in the art of trimmer heads. Washer 17 serves to protect head compressor 15 from spinning motion of trimmer head 1. Once the trimmer head is spinning 1, it functions as a normal trimmer head common in the art.

In practice, when it is desired to index out more line 3, the operator 1 may squeeze handle 4, which through cable 5 remotely actuates lever 7. See FIGS. 1 and 5. As said first end 10 is pulled upwards, the pulling force is transferred to lever 7, which rotates counter-clockwise about lever axis 9, thereby lowering second end 11. See FIGS. 5 and 6. This mechanical force is transferred directly to washer 17, which pushes downwards on the trimmer head shell 20. As the trimmer head 1 has a trimmer head base 23 in a fixed position due to securing of a core nut 24, the mechanical force pushing downwards on the trimmer head shell 20 compresses the trimmer head 1. Trimmer head base 23 does not change positions relative to the trimmer shaft during the transition from configuration 1 to configuration 2.

After a set amount of line is indexed out, the operator of the device releases handle 4 (See FIG. 1), relaxing the tension on cable 5. Normal bump-n-feed trimmers employ the use of a spring to return the head to its original configuration after compression due to striking against the ground, and in this case a spring 26 is depicted in FIGS. 5 and 6. Spring 26, under pressure in FIG. 6, returns to the first configuration (depicted in FIG. 5), and expanding the trimmer head 1 to its original starting position.

Because the head in a trimmer equipped with applicant's trimmer compressor will likely not be repeatedly pressed against the ground during normal use, the trimmer head design and components may be lighter and less robust than a typical bump-n-feed head, yet wear out no sooner. This allows a lower torque motor to be used, thereby reducing the total weight of the string trimmer.

One hurdle overcome by the applicant is in regard to the wear caused at the contact point between nonmoving and moving parts of the invention. Without the washer 17, the lever 7 (not rotating) would come into contact with the trimmer head shell 20, which is rotating because of its connection through the hex groove 22 to shaft nut 21 each time the operator actuates handle 4. The washer 17 serves in this respect to absorb some of the forces. During normal operation (i.e. when line is not being indexed and the device is in the first configuration), washer contact will be minimalized because little to no pressure is being exerted through the lever—washer—trimmer head shell connection.

Although the design above was described in accordance with the provided figures, there are numerous designs of trimmer heads which operate through compression of the head by a “bump” on the ground. For each trimmer head design activated by compression of the head, the system described above applies. While the figures in this application disclose a means to automatically index the line in one type of bump-n-feed trimmer, alternative embodiments are capable of performing the same automatic indexing action on other bump-n-feed trimmer heads. In short, the need to “bump” the head of a conventional “bump-n-feed” trimmer to the ground is one, hence they trimmers head in the bump-n-feed class should more properly be referred to as “compress-n-feed.” Thus, for purposes of this application, the term bump-n-feed shall more properly indicate any trimmer head that actuates line due to compression forces acting on the head.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A method of indexing the line of a bump-n-feed trimmer comprising:
a. providing a head compressor comprising;
i. a handle;
ii. a cable attached to said handle;
iii. a lever attached to said cable, said lever having a first end and a second end;
b. squeezing said handle such that said cable pulled said first end, thereby extending said second end, whereby said second end compresses a trimmer head; and
c. releasing said handle.

2. The method of indexing the line of a bump-n-feed trimmer according to claim 1 wherein said lever before extension is in a first configuration and wherein said lever after extension is in a second configuration, and wherein said trimmer head comprises a spring, and said spring returns said level to said first configuration immediately subsequent to said releasing step.

3. A method of compressing the head of a bump-n-feed type trimmer without bumping said head against a surface, the method comprising:
a. providing a head compressor comprising;
i. a lever attached to a cable, said lever having a first end and a second end;
b. pulling said cable such that a pulling force is exerted on said first end;
c. transferring said force to said lever second end;
d. said transferred force thereby compressing a trimmer head.

4. The method of method of compressing the head of a bump-n-feed type trimmer according to claim 3 wherein said lever before extension is in a first configuration and wherein said lever after extension is in a second configuration, and wherein said trimmer head comprises a spring, and said spring returns said level to said first configuration immediately subsequent to said releasing step.

5. The method of 4 further comprising squeezing a handle wherein said handle is connected to said cable.

6. A trimmer head compressor comprising:
a. A cable
b. a lever attached to said cable, said lever having a first end and a second end, said lever having a first configuration and a second configuration; and
c. wherein in said second configuration said second end exerts a compressing force on a trimmer head.

7. The trimmer head compressor of claim 6 wherein said compressing force indexes an amount of a trimmer line from said trimmer head.

8. The trimmer head compressor of claim 7 wherein said trimmer head further comprises a spring, said spring resistant to the force of said compression.

9. The trimmer head compressor of 8 further comprising a handle attached to said cable.

10. The trimmer head compressor of 6 further comprising a handle attached to said cable.
